(19) United States
(12) Patent Application Publication
(10) Pub. No.: US 2013/0333049 A1
(43) Pub. Date: Dec. 12, 2013

(54) DATA PROTECTION METHOD FOR PORTABLE ELECTRONIC DEVICE AND COMPUTER PROGRAM PRODUCT FOR THE SAME

(71) Applicant: CHANG-WEN CHENG, ZHUNAN TOWNSHIP (TW)

(72) Inventor: CHANG-WEN CHENG, ZHUNAN TOWNSHIP (TW)

(73) Assignee: ASKEY COMPUTER CORP.

(21) Appl. No.: 13/590,222

(22) Filed: Aug. 21, 2012

(30) Foreign Application Priority Data
Jun. 7, 2012 (TW) 101120504

(51) Int. Cl. G06F 21/00

(52) U.S. Cl. 726/26

(57) ABSTRACT

A data protection method for a portable electronic device and a computer program product for the same are applicable to a portable electronic device operating on a Linux operating system. A storage region of the portable electronic device is partitioned to provide a specific partition for storing data to be protected. The specific partition will be mounted, and the data to be protected will be displayed, only if the data to be protected contains an execution command, otherwise the specific partition will be unmounted. Hence, the specific partition is only available when it is confirmed that the data to be protected contains an execution command. Accordingly, unspecific commands, such as file browsing, cannot enable the mounting of the specific partition, thereby hiding the specific partition and enhancing the security of the data to be protected.

### CROSS-REFERENCE TO RELATED APPLICATION

This non-provisional application claims priority under 35 U.S.C. §119(a) on Patent Application No(s).101120504 filed in Taiwan, R.O.C. on Jun. 7, 2012, the entire contents of which are hereby incorporated by reference.

### FIELD OF TECHNOLOGY

The present invention relates to data protection methods and computer program products for the same, and more particularly, to a data protection method for a portable electronic device and a computer program product stored therein for use in data protection.

### BACKGROUND

Due to advancement of electronic technology, portable electronic devices nowadays are usually equipped with robust central processing units (CPU) whereby users perform various operations. The portable electronic devices are each connected to a computer for data browsing and usage.

An Android platform developed in accordance with an open Linux operating system is widely applicable to portable electronic devices nowadays. The open operating system allows a program developer to access desirable development resources and develop various platforms at the Linus system core level. Important personal data, such as usernames and passwords, stored in the portable electronic devices by users are likely to be retrieved and reproduced from the portable electronic devices directly by any unauthorized person. For example, Android Debug Bridge (ADB) which operates on the Android platform can read the aforesaid important personal data readily.

### SUMMARY

It is an objective of the present invention to protect important user-specific data.

Another objective of the present invention is to prevent the specific important data stored in the portable electronic devices from being accessed by means of file browsing.

In order to achieve the above and other objectives, the present invention provides a data protection method for a portable electronic device, applicable to a portable electronic device operating on a Linux operating system, wherein a storage region of the portable electronic device is partitioned to provide a specific partition for storing data to be protected. The data protection method comprises the steps of: (a) determining whether there is an execution command for the data to be protected; (b) mounting the specific partition so as to display the specific partition on the Linux operating system and go to step (c) when the determination is affirmative, and going back to step (a) when the determination is negative; (c) executing the execution command for the data to be protected; and (d) unmounting the specific partition so as to hide the specific partition on the Linux operating system and go back to step (a).

In an embodiment, the execution command for the data to be protected comprises a writing request and a reading request which correspond to a writing operation and a reading operation, respectively, wherein step (a) further comprises determining whether there is one of the writing request and the reading request for the data to be protected, wherein step (c) further comprises writing the data to be protected to the specific partition by the writing operation and reading the data to be protected from the specific partition by the reading operation.

In an embodiment, step (a) further comprises performing an encryption process on the data to be protected such that the data to be protected are presented in an encrypted state and then going to step (b) when it is determined that there is the writing request for the data to be protected. When it is determined that there is the reading request, step (c) further comprises, in response to the reading request, reading from the specific partition the encrypted data to be protected and performing a decryption process on the data to be protected, such that the data to be protected are presented in a decrypted state.

In an embodiment, an Android platform is constructed on a portable electronic device operating on the Linux operating system.

The present invention further provides a computer program product stored and adapted for data protection. The computer program product performs, after a portable electronic device operating on an Android platform has been mounted on the computer program product, the aforesaid method.

Accordingly, the selective mounting and unmounting of a specific partition enables the specific partition to be displayed only upon confirmation that an execution command is available. That is to say, other operation-related commands are still incapable of enabling the mounting of the specific partition even though they are in possession of root authority, thereby enhancing the security of the data to be protected. Although other simple browsing tools or network connection tools, such as the Android Debug Bridge (ADB), have root authority, they cannot enable the mounting of the specific partition because they are not specific execution commands. Therefore, the data protection method of the present invention enhances the security of the data to be protected.

### BRIEF DESCRIPTION OF THE DRAWINGS

Objectives, features, and advantages of the present invention are hereunder illustrated with specific embodiments in conjunction with the accompanying drawings, in which:

FIG. 1 is a function block diagram of a portable electronic device capable of data protection according to an embodiment of the present invention;

FIG. 2 is a flow chart of a data protection method for a portable electronic device according to an embodiment of the present invention;

FIG. 3 is a flow chart of the data protection method of FIG. 2 according to another embodiment of the present invention; and

FIG. 4 is a flow chart of a data protection method for a portable electronic device according to another embodiment of the present invention.

### DETAILED DESCRIPTION

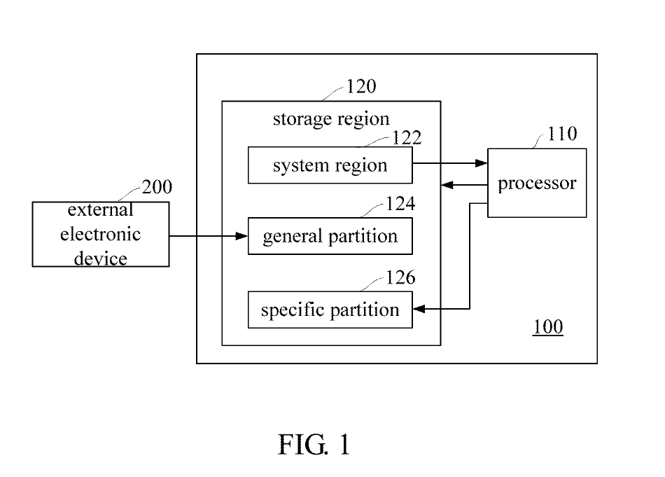

Referring to FIG. 1, there is shown a function block diagram of a portable electronic device 100 capable of data protection according to an embodiment of the present invention. The portable electronic device 100 is a personal digital assistant (PDA), a cell phone, or a tablet computer. As shown in FIG. 1, the portable electronic device 100 is connected to an external electronic device 200 (such as a computer), so as for the portable electronic device 100 to function as a USB flash drive. The portable electronic device 100 comprises a processor 110, a storage region 120, a system region 122, a general partition 124, and a specific partition 126.

The storage region 120 is provided by a memory, such as a hard disk drive or a semiconductor memory. If the external electronic device 200 and the portable electronic device 100 are connected, the user can browse data stored in the general partition 124. The Linux operating system is installed in the system region 122. In a preferred embodiment, an Android platform is constructed on the Linux operating system.

Given program configuration, the Linux operating system instructs the processor 110 to mount or unmount the specific partition 126, so as to hide (unmount) or display (mount) the specific partition 126 selectively.

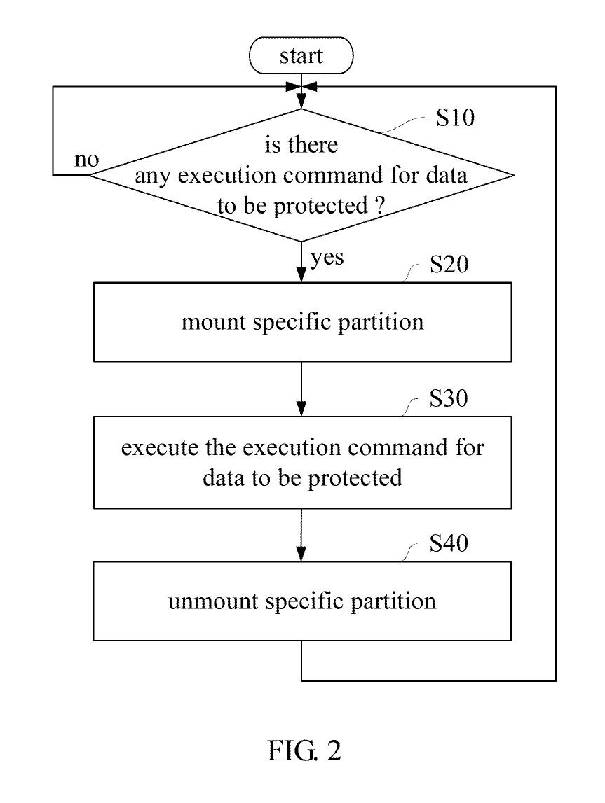

Referring to FIG. 2, there is shown a flow chart of a data protection method for a portable electronic device according to an embodiment of the present invention. A program product for operating the data protection method resides in the Linux operating system and monitors data access. The data protection method configures in advance the class or type of the data to be protected, such that the display of the specific partition 126 can be enabled as soon as the data to be protected need to be stored or read. FIG. 2 illustrates the process flow of the data protection method as follows.

Step S10 involves determining whether there is an execution command for the data to be protected. Perform step S10 again when the determination is negative. Go to step S20 when the determination is affirmative.

Step S20 involves mounting the specific partition 126 so as to display the specific partition 126 on the Linux operating system.

Step S30 involves executing the execution command for the data to be protected.

Step S40 involves unmounting the specific partition so as to hide the specific partition 126 on the Linux operating system and go back to step S20.

The aforesaid execution command is intended to process the data to be protected and is different from unspecific commands, such as a browsing command.

In an embodiment, the execution command for the data to be protected comprises a writing request and a reading request. The writing request and the reading request request execution operations, namely a writing operation and a reading operation, respectively. That is to say, either one of the writing operation and the reading operation indicates that an execution command for data to be protected is available.

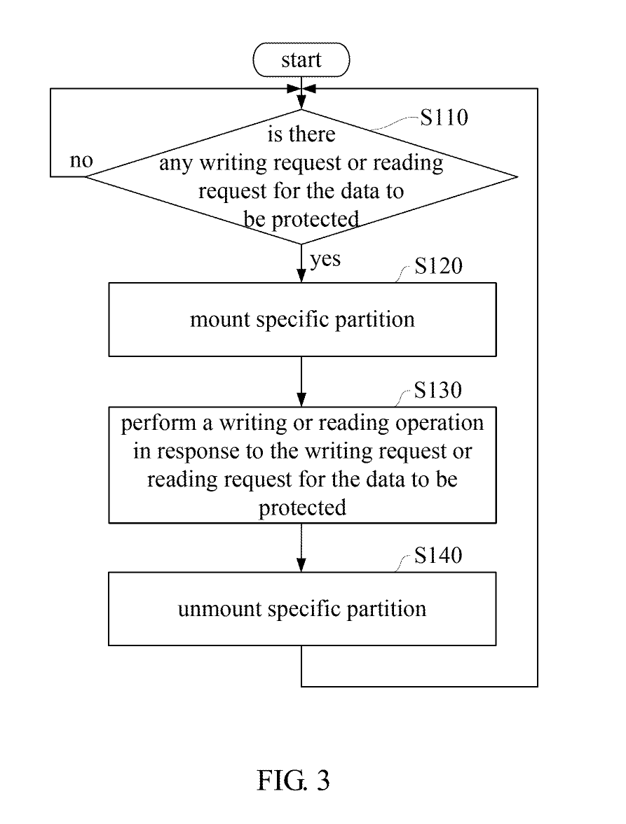

FIG. 3 illustrates the role played by the writing request and the reading request in the process flow of the data protection method according an embodiment of the present invention as follows:

Step S110 involves determining whether there is a writing request or a reading request for the data to be protected. Perform step S110 again when the determination is negative. Go to step S120 when the determination is affirmative.

Step S120 involves mounting the specific partition 126 so as to display the specific partition 126 on the Linux operating system and go to the next step.

Step S130 involves writing the data to be protected to the specific partition 126 in response to the writing request or reading the data to be protected from the specific partition 126 in response to the reading request.

Step S140 involves unmounting the specific partition 126 so as to hide the specific partition 126 on the Linux operating system and go back to step S110.

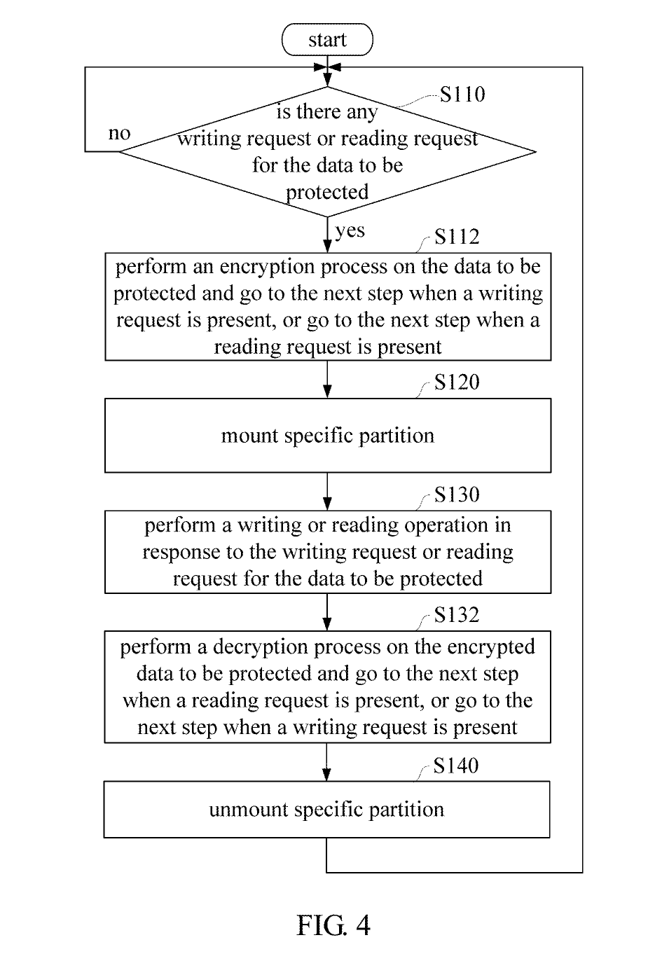

Referring to FIG. 4, there is shown a flow chart of a data protection method for a portable electronic device according to another embodiment of the present invention. The process flow of FIG. 4 is distinguished, by steps S112, S132 therein, from the process flow of FIG. 3. Steps S112, S132 of FIG. 4 are described below.

Step S112 follows step S110, when the determination in step S110 is affirmative, that is, when it is determined in step S110 that the data to be protected are to be written to or read from the specific partition 126. If step S110 determines that there is a writing request, step S112 will involve performing an encryption process on the data to be protected, such that the data to be protected are presented in an encrypted state, and then step S112 will be followed by step S120. If step S110 determines that there is a reading request, step S112 will involve doing nothing and then going to step S120. The encryption process entails enhancing the security of data stored in the specific partition 126 according to the prior art, that is, by means of an Advanced Encryption System (AES) encryption algorithm or any other appropriate algorithm. Hence, even if the data to be protected and stored are displayed as a result of the mounting of the specific partition 126 in an unexpected situation, it will be unlikely that the data to be protected can be accessed in their original form, because the data to be protected are encrypted.

Step S120 is followed by step S130, and step S130 by step S132. In response to a reading request, step S132 involves performing a decryption process on the data to be protected and encrypted, such that the data to be protected are presented in a decrypted state and therefore can be read. In response to a writing request, step S132 involves doing nothing and then going to step S140.

In practice, to access a file stored in the specific partition 126, it is necessary to mount the specific partition 126. In the Linux operating system, mounting is executed by a mount command, and unmounting by an unmount command

In the Linux operating system, it is necessary for a created specific partition (/dev/spepartition, for example) to be mounted in a subdirectory (/spe, for example) or a directory under the root directory, such that the created specific partition can be accessed. The mounted directory or subdirectory is known as a mount point, and data stored in the mounted subdirectory (/spe) disappear temporarily. The Linux operating system intrinsically supports plenty of file systems, such as minix, ext2, ext3, reiserfs, ntfs, vfat, msdos, iso9660 (CD-ROM), udf (DVD-ROM), as well as network-based file systems, such as nfs, smbfs. The description below is exemplified by command strings.
For instance:
# create the mount point of /dev/spepartition to be /spe:
suse:˜# mkdir/mnt/spe
# execute mount (assuming that /dev/spepartition has just been formatted to become the file system ext3):
suse:˜# mount-t ext3 /dev/spepartition /mnt/spe

In doing so, the mount operation is done. Furthermore, Linux provides other commands for specifying the states (such as a readable and writable state) of a mounted partition, which are known among persons skilled in the art and thus are omitted from the description below for the sake of brevity.
to unmount:
# excise mount point:
suse:/mnt/ spe # cd
# perform unmounting:
suse:˜# umount /mnt/spe

Therefore, the timing of displaying the data to be protected can be controlled by mounting and unmounting a specific partition selectively. For instance, a cell phone manufacturer can store account-related data and passwords created by users in a specific partition in the aforesaid manner and configure the cell phone in a manner that the specific partition will not be mounted when the cell phone is reset to factory defaults. In doing so, after users have reset their cell phones to factory defaults, account-related data can be easily restored.

The number of failed password entry attempts to a cell phone can also be stored in the specific partition. Therefore, persons not in possession of the cell phone cannot zero the number of failed password entry attempts easily by resetting the cell phone to factory defaults in attempt to maximize the chance of cracking the password.

In conclusion, a specific partition is displayed only upon confirmation that data to be protected are to be read from or written to the specific partition, wherein other operation-related commands are still incapable of enabling the mounting of the specific partition even though they are in possession of root authority, thereby enhancing the security of the data to be protected.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A data protection method for a portable electronic device, applicable to a portable electronic device operating on a Linux operating system, wherein a storage region of the portable electronic device is partitioned to provide a specific partition for storing data to be protected, the data protection method comprising the steps of:
(a) determining whether there is an execution command for the data to be protected;
(b) mounting the specific partition so as to display the specific partition on the Linux operating system and go to step (c) when the determination is affirmative, and going back to step (a) when the determination is negative;
(c) executing the execution command for the data to be protected; and
(d) unmounting the specific partition so as to hide the specific partition on the Linux operating system and go back to step (a).

2. The data protection method of claim 1, wherein the execution command for the data to be protected comprises a writing request and a reading request which correspond to a writing operation and a reading operation, respectively, wherein step (a) further comprises determining whether there is one of the writing request and the reading request for the data to be protected, wherein step (c) further comprises writing the data to be protected to the specific partition by the writing operation and reading the data to be protected from the specific partition by the reading operation.

3. The data protection method of claim 2, wherein step (a) further comprises performing an encryption process on the data to be protected such that the data to be protected are presented in an encrypted state and then going to step (b) when it is determined that there is the writing request for the data to be protected.

4. The data protection method of claim 3, wherein, when it is determined that there is the reading request, step (c) further comprises, in response to the reading request, reading from the specific partition the encrypted data to be protected and performing a decryption process on the data to be protected, such that the data to be protected are presented in a decrypted state.

5. The data protection method of claim 1, wherein an Android platform is constructed on a portable electronic device operating on the Linux operating system.

6. A computer program product stored and adapted for data protection performs, after a portable electronic device operating on an Android platform has been mounted on the computer program product, the method of claim 1.

7. A computer program product stored and adapted for data protection performs, after a portable electronic device operating on an Android platform has been mounted on the computer program product, the method of claim 2.

8. A computer program product stored and adapted for data protection performs, after a portable electronic device operating on an Android platform has been mounted on the computer program product, the method of claim 3.

9. A computer program product stored and adapted for data protection performs, after a portable electronic device operating on an Android platform has been mounted on the computer program product, the method of claim 4.
